(19) United States
(12) Patent Application Publication
(10) Pub. No.: US 2009/0163670 A1
(43) Pub. Date: Jun. 25, 2009

(54) ORGANIC-INORGANIC HYBRID MATERIAL, GAS BARRIER FILM AND METHOD FOR PRODUCING THE SAME

(75) Inventors: Toshihide Aoshima, Shizuoka (JP); Koichi Kawamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 12/096,440

(22) PCT Filed: Dec. 8, 2006
(86) PCT No.: PCT/JP2006/324985

§ 371 Date: Jun. 6, 2008

(30) Foreign Application Priority Data
Dec. 12, 2005 (JP) 2005-358182
Mar. 30, 2006 (JP) 2006-095443

(51) Int. Cl. C08G 79/00

(52) U.S. Cl. 525/389

(57) ABSTRACT

The invention provides an organic-inorganic hybrid material including: a support, and a graft polymer layer containing a graft polymer chain directly bonding to a surface of the support or a surface layer provided on the support, the graft polymer layer containing an inorganic component including a crosslinked structure formed through hydrolysis and polycondensation of an alkoxide of an element selected from Si, Ti, Zr and Al. The organic-inorganic hybrid material is useful as a gas barrier film.

### TECHNICAL FIELD

The present invention relates to an organic-inorganic hybrid material formed through hydrolysis and polycondensation of an alkoxide compound in a graft polymer layer directly bonding to a surface of a substrate, and to an organic-inorganic hybrid-type gas barrier film suitable for wrapping materials that are required to have airtight sealability and oxygen-barrier capability for foods, medicines, electronic parts, etc., as well as to a method for producing the same.

### BACKGROUND ART

Heretofore, polypropylene films having excellent water vapor-barrier capability have been used for wrapping transparent gas barrier films, and when they are required to have high oxygen-barrier capability, then the polypropylene films are subjected to various surface treatments. The surface treatment comprises, for example, (1) coating the surface of a polypropylene film with a resin having a relatively excellent gas barrier capability such as polyvinylidene chloride, polyvinyl alcohol or an ethylene-vinyl alcohol copolymer, or laminating the film with a film of the resin having a relatively excellent gas barrier capability to thereby construct a double-layer structure of the resin film and the polypropylene film, (2) sticking aluminum foil to the surface of a polypropylene film, or coating the film surface with aluminum through vacuum evaporation to thereby form a thin metal film thereon, or (3) coating the surface of a polypropylene film with an inorganic compound (e.g., a metal oxide such as aluminum oxide, or silicon oxide) through vapor deposition to form a thin inorganic compound film thereon.

The polypropylene film processed according to the above surface treatment (1) is much used because of its transparency, workability and economy. However, in the above surface treatment (1), the gas barrier film with polyvinylidene chloride is problematic in that it releases hydrogen chloride gas when discarded and incinerated, and may therefore damage incinerators, or depending on the incineration condition, it may cause environmental pollution. In the surface treatment (1), those that use polyvinyl alcohol and ethylene-vinyl alcohol copolymer are free from problems related to incineration, however, as they may readily absorb water, their gas barrier capability to oxygen and water vapor in a high-temperature and high-humidity condition may be insufficient and they are therefore problematic in that their use may be limited.

The polypropylene film processed through the above surface treatment (2) lacks the visibility of the matter wrapped inside it, but is excellent in its beautiful appearance and gas barrier capability to water vapor and oxygen. However, since a gas barrier film of this type does not transmit microwaves, there is a problem in that it cannot be used in microwave ovens. Other problems are that the proportion of the cost of the aluminum foil to the overall production cost of the wrapping material is high and, after incineration, the film leaves aluminum lumps. In addition, when aluminum foil is used, while its gas barrier capability may be good it has a drawback in that the wrapping material using aluminum foil is too heavy owing to the influence of a thickness of tens of μm.

The polypropylene film processed through the above surface treatment (3) has become much used recently as it is transparent and lightweight. However, in the polypropylene film merely coated with an inorganic compound (e.g., a metal oxide such as aluminum oxide, or silicon oxide) through vapor deposition, the deposition film is preferably thicker in order to exhibit a good oxygen-barrier capability; but if the deposition film is too thick, it is problematic in that the film is not be flexible and is colored such that it loses transparency and, moreover, the vapor deposition cost is high. In addition, the adhesiveness between the polypropylene film and the thin inorganic compound film is often insufficient, and the thin inorganic compound film may peel off or may crack, therefore causing a problem in that the gas barrier capability of the film may be reduced.

As in the above, it has heretofore been difficult to obtain a gas barrier film which can be easily handled as a material, which has the intended gas barrier capability and which is excellent in the durability of its gas barrier capability.

For the purpose of solving these problems, a gas barrier film having a thin inorganic film formed on the surface of a substrate film, which is produced through adsorption of an inorganic material by the substrate, taking advantage of the strong ionic absorbability of the hydrophilic surface of the substrate having hydrophilic graft polymer chains existing therein has been proposed (e.g., see JP-A 2004-136638). The film has excellent gas barrier capability, but still needs to have its durability further improved.

### DISCLOSURE OF THE INVENTION

The invention has been made in consideration of the above-mentioned circumstances, and provides an organic-inorganic hybrid material having a high-density crosslinked structure and applicable to various fields, to provide a gas barrier film excellent in adhesiveness between the base film and the gas barrier layer thereon and excellent in durability, and excellent in the visibility through it and in its gas barrier capability, and to provide a method for producing the same.

The present inventors have specifically noted the point that an organic-inorganic hybrid material has a tight network structure and prevents dissolution and diffusion of molecules, and have investigated hydrolysis and polycondensation reactions of a metal alkoxide in a graft polymer layer. With that, the present inventors further promoted their studies of a support that has, on its surface, an organic-inorganic hybrid structure of the graft polymer and the inorganic compound, and, as a result, have found that a hybrid material of a graft polymer chain directly bonding to a surface of a support or to a surface layer provided on the support, and an inorganic compound has excellent adhesiveness to a substrate, and may give strong functional thin films capable of having various applications. In addition, they have further found that when a support with such hydrophilic graft polymer chains existing in its surface is used, then the above-mentioned problems can be solved, and thus have completed the present invention.

Specifically, a first aspect of the invention is to provide an organic-inorganic hybrid material comprising: a support, and a graft polymer layer containing a graft polymer chain directly bonding to a surface of the support or a surface layer provided on the support, the graft polymer layer containing an inorganic component comprising a crosslinked structure formed through hydrolysis and polycondensation of an alkoxide of an element selected from Si, Ti, Zr and Al.

A second aspect of the invention is to provide a gas barrier film comprising: a support, and a gas barrier layer consisting of a graft polymer layer containing a graft polymer chain directly bonding to a surface of the support or a surface layer provided on the support, the graft polymer layer containing an inorganic component comprising a crosslinked structure formed through hydrolysis and polycondensation of an alkoxide of an element selected from Si, Ti, Zr and Al.

Preferably, the graft polymer chain is formed through polymerization that starts from the initiation site generated in the support or in the surface layer formed on the support.

In one preferred embodiment of the invention, the gas barrier layer is formed of an organic-inorganic hybrid material (organic-inorganic hybrid film) having a crosslinked structure formed through hydrolysis and polycondensation of an alkoxide of an element selected from Si, T, Zr and Al, and the graft polymer chain to form the gas barrier layer is a copolymer of a structural unit having a hydrophilic functional group and a structural unit having an alkoxide group with an element selected from Si, Ti, Zr and Al such as a silane-coupling group, or an amido group capable of forming a polar interaction.

Preferably, the graft polymer layer having a graft polymer chain directly bonding to the surface of the support or to the surface layer provided on the support, which is for forming the organic-inorganic hybrid material as above, has a contact angle of 90° or less of water to the surface thereof before forming the crosslinked structure therein. Also preferably, the graft polymer layer contains the inorganic component that has the crosslinked structure formed through hydrolysis and polycondensation of an alkoxide of an element selected from Si, Ti, Zr and Al, or that is, the graft polymer layer before formation of the crosslinked structure therein has a degree of hydrophilicity as above.

In forming the crosslinked structure as above through hydrolysis and polycondensation of an alkoxide of an element selected from Si, Ti, Zr and Al in the graft polymer layer, it is desirable that the graft polymer chain directly bonding to the surface of the support or to the surface layer provided on the support may have in its structure an alkoxide group of an element selected from Si, Ti, Zr and Al or an amido group, from the viewpoint of improving the crosslinking density. For introducing the group into the graft polymer chain, a method of introducing a structural unit having such a functional group thereinto through copolymerization during the formation of the graft chain is preferred, as so mentioned in the above.

These preferred embodiments are also useful in forming gas barrier films.

The third aspect of the invention is to provide a method for producing a gas-carrier film comprising: generating a graft polymer chain directly bonding to a surface of a support or a surface layer provided on the support, thereby forming a graft polymer layer containing a graft polymer chain; and forming a crosslinked structure in the graft polymer layer through hydrolysis and polycondensation of an alkoxide of an element selected from Si, Ti, Zr and Al.

Preferably, the surface layer provided on the support is formed by providing a polymerization initiating layer which is formed by fixing a polymerization initiator on the surface of the support through a crosslinking reaction.

Specifically, the method for forming the surface layer comprises a support-producing process of providing a polymerization initiating layer which is formed by fixing a polymerization initiator on the surface of the support through a crosslinking reaction, followed by generating an active site in the polymerization initiating layer by giving energy thereto through plasma irradiation, light irradiation or heating, and bonding a compound having a polymerizable functional group to the layer through graft polymerization starting from the active site, thereby forming graft polymer chains. The energy impartation to the surface layer of the support may be attained while the compound having the polymerizable functional group is kept in contact with the surface; or after the energy impartation, a compound having a polymerizable functional group may be brought into contact with the surface.

Though not clear, the functional mechanism of the invention is assumed to be as follows.

In the invention, an organic-inorganic hybrid material is obtained, in which hydrophilic graft polymer chains directly bond to the support or to the surface layer formed on the surface of the support and in which the crosslinked structure obtained through hydrolysis and polycondensation of an alkoxide compound exists at a high density through the polar interaction thereof owing to the function of the polar group existing in the graft polymer chains.

Further, in a preferred embodiment of the invention, a graft polymer having, along with the above polar group, an alkoxide group of an element selected from Si, Ti, Zr and Al, is used, and therefore a covalent crosslinked structure is formed at a higher density in forming an organic-inorganic hybrid film through the subsequent hydrolysis and polycondensation of the alkoxide of an element selected from Si, Ti, Zr and Al with the result that the adhesiveness, the strength and the durability of the thus-formed hybrid film may be thereby remarkably improved. When a graft polymer having an amido group is used, then the density of the crosslinked structure may be increased owing to the polar interaction thereof, therefore contributing to the adhesiveness, the strength and the durability of the formed hybrid film.

The layer having such a high-density crosslinked structure exhibits high gas barrier capability, and when it is used as a gas barrier layer, then its resistance to abrasion may be increased even though it is thin, with the result that the resulting gas barrier layer can have high durability. The adhesiveness between the two relies upon the fact that the support (or its surface layer) and the gas barrier layer constitute an organic-inorganic hybrid thin film (organic-inorganic hybrid material), and the high adhesiveness between the two is kept even though an intermediate layer including a binder or the like is not provided therebetween. Accordingly, the gas barrier layer in the invention has another advantage in that its transparency is excellent.

### BEST MODE FOR CARRYING OUT THE INVENTION

The invention is described in detail below.

The organic-inorganic hybrid material of the invention includes a support, and a graft polymer layer containing a graft polymer chain directly bonding to a surface of the support or a surface layer provided on the support, the graft polymer layer containing an inorganic component including a crosslinked structure formed through hydrolysis and polycondensation of an alkoxide of an element selected from Si, Ti, Zr and Al.

The gas barrier film of the invention to which the organic-inorganic hybrid material is applied includes a support, and a gas barrier layer including a graft polymer layer containing a graft polymer chain directly bonding to a surface of the support or a surface layer provided on the support, the graft polymer layer containing an inorganic component including a crosslinked structure formed through hydrolysis and polycondensation of an alkoxide of an element selected from Si, Ti, Zr and Al.

The alkoxide is preferably an alkoxide of Si in view of its reactivity and easy availability.

The crosslinked structure formed through hydrolysis and polycondensation of the above-mentioned metal alkoxide may be referred to as a sol-gel crosslinked structure in the invention.

The method for producing the gas barrier film is not particularly limited, and preferably includes: (1) generating a graft polymer chain directly bonding to a surface of a support or a surface layer provided on the support, thereby forming a graft polymer layer containing a graft polymer chain, and (2) forming a crosslinked structure in the graft polymer layer through hydrolysis and polycondensation of an alkoxide of an element selected from Si, Ti, Zr and Al. More precisely, the method preferably includes processes (1-1) forming a polymerization initiating layer in which a polymerization initiator is fixed through a crosslinking reaction on a surface of the support, (1-2) contacting a compound having a polymerizable functional group with the polymerization initiating layer, generating a graft polymer thereby bonding the compound to a surface of the polymerization initiating layer though graft polymerization by irradiating with a radiation ray, and (2) forming a crosslinked structure in the graft polymer layer through hydrolysis and polycondensation of an alkoxide of an element selected from Si, Ti, Zr and Al; or preferably includes processes (1-1) forming a polymerization initiating layer in which a polymerization initiator is fixed through crosslinking reaction on a surface of the support, (1-2′) irradiating the polymerization initiating layer with a radiation ray, and then contacting a compound having a polymerizable functional group with the surface of the polymerization initiation thereby bonding the compound to the surface of the polymerization initiating layer through graft polymerization to generate a graft polymer chain, and (2) forming a crosslinked structure in the graft polymer layer through hydrolysis and polycondensation of an alkoxide of an element selected from Si, Ti, Zr and Al.

<Support with a Hydrophilic Graft Polymer Chain Existing Thereon>

The support for forming thereon the gas barrier layer having a crosslinked structure in the invention may be produced by preparing a hydrophilic graft polymer according to a production method generally known for producing graft polymers, then crosslinking it according to a process of forming a sol-gel crosslinked structure mentioned in detail hereinunder. Specifically, the production of graft polymers is described in “Graft jyugo to sono oyo” (“Graft Polymerization and Its Application”), by Fumio Ide, issued in 1977 by the Polymer Publishing Association of Japan; and “Shin kobunshijikken gaku 2, Kobunshi no gosei hanno” (“New Polymer Experimentation 2, Synthesis and Reaction of Polymer”), edited by the Polymer Society of Japan, published by Kyoritsu Publishing, 1995.

A hydrophilic surface of the support in the invention is meant to indicate the surface thereof where a hydrophilic graft polymer chain exist. To construct the constitution, an initiation site serving as a start point is generated in a support or in a surface layer provided on the surface of a support, and a compound capable of reacting with the initiation site is bonded to the support to thereby form the intended graft polymer chain on or above the support. Having the constitution, the thus-formed hydrophilic graft polymer chain may directly bond to the support or to its surface layer. The support capable of generating the initiation site for use herein may be one capable of generating an active site in the structure of the support; or a surface layer that facilitates the bonding of a graft polymer to the surface of a substrate may be provided to be a support for use herein, in which a hydrophilic graft polymer chain directly bonding to the surface layer may be formed.

<Support Having a Hydrophilic Surface with a Hydrophilic Graft Polymer Chain Existing Thereon>

As mentioned above, the hydrophilic surface of the support in the invention is meant to indicate the surface thereof where a hydrophilic graft polymer chain exist. In this, the hydrophilic graft polymer chain may directly bond to the surface of the support, or an intermediate layer to which a graft polymer may readily bond may be provided on the surface of the support, and a hydrophilic polymer may be grafted to the layer.

The hydrophilic surface in the invention includes a configuration of such that a polymer with a hydrophilic graft polymer chain bonding to a stem polymer compound, or a polymer with a hydrophilic graft polymer chain bonding to a stem polymer compound and with a crosslinkable functional group introduced thereinto is applied to, or applied to and crosslinked on the surface of a support; and a configuration of such that a composition comprising a hydrophilic polymer with a crosslinkable group at the terminal thereof and a crosslinking agent is applied to, or applied to and crosslinked on the surface of a support.

The hydrophilic graft polymer chain in the invention is characterized in that the polymer terminal bonds to the surface of the support or to the surface layer of the support and that the hydrophilic grafts are not substantially crosslinked. Having the structure, the polymer is characterized by having high mobility, in which the mobility of the polymer moiety that expresses hydrophilicity is not limited and the polymer moiety is not buried in the tough crosslinked structure of the polymer. Accordingly, as compared with a hydrophilic polymer having an ordinary crosslinked structure, the hydrophilic polymer in the invention may express adsorbability, for example, to metal and metal particles.

The molecular weight (Mw), of the hydrophilic graft polymer chain is preferably in a range of from 500 to 5,000,000, more preferably from 1,000 to 1,000,000, particularly preferably from 2,000 to 500,000.

The contact angle of water to the surface of the graft polymer layer, before processed for gas barrier layer formation to produce an organic-inorganic hybrid film mentioned hereinunder, is preferably 90° or less, more preferably 80° or less. The contact angle of water in the invention is a value determined according to a method of measuring the angle of a pure water drop in 20 seconds after its dropping, using Kyowa Kaimen Kagaku's CA-Z.

In the invention, a hydrophilic graft polymer chain directly bonding to the surface of a support or to a intermediate layer provided on a surface of a support is referred to as “surface graft”. In the invention, a material of the support or the support with an intermediate layer formed thereon is referred to as “substrate”.

### [Method of Forming Surface Graft]

For forming a surface having a hydrophilic group which is formed by a graft polymer on a substrate, employable are two methods, (1) a method of bonding a substrate and a graft polymer through chemical bonding to each other; and (2) a method of polymerizing a polymerizable double bond-having compound on a substrate serving as a reaction start to give a graft polymer.

### (1) Method of Bonding Substrate and Graft Polymer Through Chemical Bonding:

First described is the method of bonding a substrate and a graft polymer through chemical bonding to each other.

In this method, a polymer having a functional group capable of reacting with a substrate at the terminal or in the side chain thereof is used, in which the functional group is chemically reacted with the functional group in the surface of the substrate for grafting therebetween; or that is, the graft polymer is bonded to the substrate through chemical reaction therebetween. The functional group capable of reacting with a substrate is not particularly limited, if it may react with the functional group in the surface of a substrate. For example, it includes an silane-coupling group such as alkoxysilane, an isocyanate group, an amino group, a hydroxyl group, a carboxyl group, a sulfonic acid group, a phosphoric acid group, an epoxy group, an allyl group, a methacryloyl group, an acryloyl group. Compounds that are especially useful as the polymer having a reactive functional group at the terminal or in the side chain thereof include a hydrophilic polymer having a trialkoxysilyl group at the polymer terminal, a hydrophilic polymer having an amino group at the polymer terminal, a hydrophilic polymer having a carboxyl group at the polymer terminal, a hydrophilic polymer having an epoxy group at the polymer terminal, and a hydrophilic polymer having an isocyanate group at the polymer terminal.

The hydrophilic polymer used in this case is not particularly limited, if it has hydrophilic property. Specifically, for example, it includes polyacrylic acid, polymethacrylic acid, polystyrenesulfonic acid, poly-2-acrylamido-2-methylpropanesulfonic acid and their salts, polyacrylamide, polyvinylacetamide. In addition, polymers of hydrophilic monomers that are used in surface graft polymerization mentioned below, as well as copolymers containing such hydrophilic monomers may also be used advantageously.

### (2) Method of Polymerization of Polymerizable Double Bond-Having Compound on Substrate Serving as Reaction Start to Give Graft Polymer:

The method of polymerizing a polymerizable double bond-having compound on a substrate (a support or a support having an intermediate layer) serving as a reaction start to give a graft polymer is generally referred to as a surface graft polymerization method. The surface graft polymerization method is meant to indicate a method where an active site is given to the surface of a substrate through plasma irradiation, light irradiation or heating, and a polymerizable double bond-having compound that is disposed to be in contact with the substrate is polymerized and is bonded to the substrate. According to this method, the terminal of the formed graft polymer is fixed to the surface of the substrate.

The surface graft polymerization method for carrying out the invention may be any known one described in literature. For example, “Shin kobunshi jikkengaku 10” (“New Polymer Experimentation 10”), edited by the Polymer Society of Japan, 1994, published by Kyoritsu Publishing, p. 135 describes an optical graft polymerization method and a plasma irradiation graft polymerization method for surface graft polymerization. “Kyuchaku gijyutsu binran” (“Adsorption Technology Handbook”), by NTS, edited by Takeuchi, published on February 1999, p. 203 and p. 695 describes a method of irradiation graft polymerization with radiations such as γ-rays or electron beams. Specifically, the methods described in JP-A 63-92658, 10-296895 and 11-119413 may be employed for optical graft polymerization. For plasma irradiation graft polymerization and radiation ray irradiation graft polymerization, employable are the methods described in the above-mentioned references and in Y. Ikeda et al., “Macromolecules”, Vol. 19, p. 1804 (1986).

Specifically, the surface of a polymer material such as PET is processed with plasma or electron beams to generate radicals on the surface thereof, and thereafter the active surface is reacted with a hydrophilic functional group-having monomer to give a graft polymer surface layer, or that is, a surface layer having a hydrophilic group (hydrophilic surface).

In addition to the methods described in the above-mentioned literature, the optical graft polymerization may also be attained by applying a photopolymerizing composition onto the surface of a film support followed by contacting the resulting substrate with an aqueous radical-polymerizing compound and exposing it to light, for example, as in JP-A 53-17407 (Kansai Paint) or JP-A 2000-212313 (Dai-Nippon Ink).

The compound useful for forming a hydrophilic graft polymer chain must have a polymerizable double bond and have a hydrophilic property. Having a double bond in the molecule, the compound for use herein may be any of a hydrophilic polymer, a hydrophilic oligomer and a hydrophilic monomer. A hydrophilic monomer is especially useful.

The hydrophilic monomer useful in the invention includes a monomer having a positive charge such as ammonium or phosphonium, or a monomer having a negative charge or having an acid group capable of dissociating into a negative charge such as a sulfonic acid group, a carboxyl group, a phosphoric acid group or a phosphonic acid group. In addition, also useful herein is a hydrophilic monomer having a nonionic group such as a hydroxyl group, an amido group, a sulfonamido group, an alkoxy group, a cyano group.

Examples of the hydrophilic monomers especially useful in the invention are the following monomers. For example, they are (meth)acrylic acid or its alkali metal salt and amine salt; itaconic acid or its alkali metal salt and amine salt; allylamine or its hydrohalide; 3-vinylpropionic acid or its alkali metal salt and amine salt; vinylsulfonic acid or its alkali metal salt and amine salt; styrenesulfonic acid or its alkali metal salt and amine salt; 2-sulfoethylene (meth)acrylate, 3-sulfopropylene (meth)acrylate or its alkali metal salt and amine salt; 2-acrylamido-2-methylpropanesulfonic acid or its alkali metal salt and amine salt; acid phosphoxypolyoxyethylene glycol (mono)methacrylate or its salt; 2-dimethylaminoethyl (meth)acrylate or its hydrohalide; 3-trimethylammoniumpropyl (meth)acrylate, 3-trimethylammoniumpropyl(meth)acrylamide, N,N,N,N-trimethyl-N-(2-hydroxy-3-methacryloyloxypropyl) ammonium chloride. In addition, also useful are 2-hydroxyethyl (meth)acrylate, (meth)acrylamide, N-monomethylol(meth)acrylamide, N-dimethylol(meth)acrylamide, N-vinylpyrrolidone, N-vinylacetamide, polyoxyethylene glycol mono(meth)acrylate and the like.

Production of graft polymers using hydrophilic macromers is described in the above-mentioned “Shin kobunshi jikkengaku 2” (“New Polymer Experimentation 2”), Synthesis and Reaction of Polymer, edited by the Polymer Society of Japan, published by Kyoritsu Publishing, 1995. In addition, it is also described in detail in Yuya Yamashita et al., “Macromonomer no kagaku to kogyo” (“Chemistry and Industry of Macromonomer”), IPC, 1989.

Specifically, using hydrophilic monomers concretely described in the above, such as acrylic acid, acrylamide, 2-acrylamido-2-methylpropanesulfonic acid and N-vinylacetamide, hydrophilic macromers may be produced according to the method described in the literature.

Hydrophilic macromers that are specially useful in the invention include macromers derived from a carboxylic group-having monomer such as acrylic acid, methacrylic acid; sulfonic acid-based macromers derived from a monomer of 2-acrylamido-2-methylpropanesulfonic acid, styrenesulfonic acid and their salt; amide-based macromers derived from acrylamide, methacrylamide; amide-based macromers derived from an N-vinylcarbonylamide monomer such as N-vinylacetamide, N-vinylformamide; macromers derived from a hydroxyl group-having monomer such as hydroxyethyl methacrylate, hydroxyethyl acrylate, glycerol monomethacrylate; and macromers derived from an alkoxy or ethyleneoxide group-having monomer such as methoxyethyl acrylate, methoxypolyethylene glycol acrylate, polyethylene glycol acrylate. In addition, monomers having a polyethylene glycol chain or a polypropylene glycol chain are also usable as macromers in the invention.

Preferably, the macromers have a molecular weight of from 400 to 100,000, more preferably from 1,000 to 50,000, particularly preferably from 1,500 to 20,000. When their molecular weight is 400 or less, then they would be ineffective; but when 100,000 or more, their polymerizability with a comonomer to form the main chain of the resulting polymer may be poor.

After the hydrophilic macromer has been produced, it may be copolymerized with any other monomer having a functional group reactive with it. In another method, a graft polymer comprising a hydrophilic macromer and having a photocrosslinking group or a polymerizing group may be produced, and it may be applied onto a support and reacted and crosslinked through exposure to light to give the intended polymer thereon.

Preferably, the hydrophilic graft polymer in the invention has “a substituent capable of forming a covalent bond through hydrolysis with a metal alkoxide” such as “an alkoxide group of an element selected from Si, Ti, Zr and Al (hereinafter this may be referred to as a specific element alkoxide group)” such as typically a silane-coupling group, as so mentioned in the above. This embodiment is hereinunder described with reference to a silane-coupling group as one example. The hydrophilic graft polymer of the type may be obtained through copolymerization of a structural unit having a specific element alkoxide group and the above-mentioned hydrophilic monomer or macromer. The specific element alkoxide group-having structural unit includes a hydrophilic monomer or macromer having a specific element alkoxide group in its side chain or terminal.

Introduction of the specific element alkoxide group is described specifically with reference to a typical specific element alkoxide group as an example. One example of the introducible silane-coupling group is a functional group of the following formula (I):

(R¹)ₘ(OR²)₃₋ₘ—Si— (I)

In formula (I), R¹ and R² each independently represent hydrogen atom, or a hydrocarbon group having 8 or less carbon atoms; and m indicates an integer of from 0 to 2.

When R¹ and R² represent a hydrocarbon group, the hydrocarbon group includes an alkyl group and an aryl group, and is preferably a linear, branched or cyclic alkyl group having 8 or less carbon atoms. Specifically, the hydrocarbon group includes a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclopentyl group.

R¹ and R² each are preferably hydrogen atom, a methyl group or an ethyl group in view of the effect and the availability of the compounds.

The hydrophilic graft polymer in the invention may be further copolymerized with any other hydrophilic monomer, in addition to the above-mentioned two structural units, or that is, the hydrophilic functional group-having macromer and the structural unit having a specific element alkoxide group such as a silane-coupling group. Also as a preferred embodiment thereof, the polymer may be copolymerized with a structural unit having an amido group capable of forming polar interaction. Regarding the examples of the copolymerizable hydrophilic monomer, referred to are those mentioned hereinabove for the hydrophilic monomer useful for forming the above-mentioned hydrophilic macromers.

After the production of the hydrophilic macromer, one method of forming the surface graft in the invention includes copolymerizing the hydrophilic macromer with a specific element alkoxide group and preferably with any other structural unit having an amido group.

The hydrophilic graft polymer obtained herein, which is a copolymer of a hydrophilic functional group-having macromer and a specific element alkoxide group-having structural unit, has a plurality of hydrophilic graft chains of good mobility and a plurality of specific element alkoxide groups that are the reaction sites for interaction with a sol-gel crosslinked layer, in the molecule, and therefore, it is useful for forming a gas barrier film of the invention.

The preferred amount of the specific element alkoxide group to be introduced into a graft polymer chain in the invention may fall within a range of from 10 wt. % to 100 wt. % of all the monomers constituting the graft polymer, in terms of the amount of the monomer fed for producing the graft polymer; and when the polymer has an amido group, then the preferred amount of the amido group to be introduced thereinto may fall within a range of from 10 wt. % to 100 wt. % of all the monomers constituting the graft polymer. Specifically, a part of the graft polymer chain formed may have a specific element alkoxide group, or all of them may have the functional group. Similarly, a part of the graft polymer chains formed may have an amido group, or all of them may have it.

A hydrophilic layer equipped with a hydrophilic graft chain and a sol-gel crosslinked structure having a hydrophilic functional group and a silane-coupling group as in the above may be readily formed, for example, by preparing a hydrophilic coating liquid composition that contains a hydrophilic graft polymer, or that is, a copolymer of a hydrophilic functional group-having macromer and a specific element alkoxide group-having structural unit as above, and preferably additionally contains a hydrolyzable compound of the following formula (II), then applying it onto a support and drying it to form a film thereon.

(R⁶)ₘ—X—(OR⁷)₄₋ₘ (II)

In formula (II), R⁶ and R⁷ each independently represent an alkyl group or an aryl group; X represents Si, Al, Ti or Zr; and m indicated an integer of from 0 to 2.

The hydrolyzable compound of the above formula (II) (hereinafter, this may be simply referred to as a hydrolyzable compound) for use herein is a hydrolyzable polymerizable compound having a polymerizing functional group in its structure and functioning as a crosslinking agent, and when polycondensed with the above-mentioned hydrophilic graft polymer, it forms a tough film having a crosslinked structure.

In formula (II), R⁶ represents hydrogen atom, an alkyl group or an aryl group; R⁷ represents an alkyl group or an aryl group; X represents Si, Al, Ti or Zr; and m indicates an integer of from 0 to 2.

The alkyl group for R⁶ and R⁷ preferably has from 1 to 4 carbon atoms. The alkyl group and the aryl group may have a substituent. The substituent introducible into them includes halogen atom, an amino group, a mercapto group.

The compound is a low-molecular compound, and its molecular weight is preferably 1000 or less.

Examples of the hydrolyzable compound of formula (II) are mentioned below, to which, however, the invention should not be limited.

When X is Si, or that is, when the hydrolyzable compound contains silicon, the compound includes, for example, trimethoxysilane, triethoxysilane, tripropoxysilane, tetramethoxysilane, tetraethoxysilane, tetrapropoxysilane, methyltrimethoxysilane, ethyltriethoxysilane, propyltrimethoxysilane, methyltriethoxysilane, ethyltriethoxysilane, propyltriethoxysilane, dimethyldimethoxysilane, diethyldiethoxysilane, γ-chloropropyltriethoxysilane, γ-mercaptopropyltrimethoxysilane, γ-mercaptopropyltriethoxysilane, γ-aminopropyltriethoxysilane, phenyltrimethoxysilane, phenyltriethoxysilane, phenyltripropoxysilane, diphenyldimethoxysilane, diphenyldiethoxysilane.

Among them, especially preferred are tetramethoxysilane, tetraethoxysilane, methyltrimethoxysilane, ethyltrimethoxysilane, methyltriethoxysilane, ethyltriethoxysilane, dimethyldiethoxysilane, phenyltrimethoxysilane, phenyltriethoxysilane, diphenyldimethoxysilane, diphenyldiethoxysilane.

When X is Al, or that is when the hydrolyzable compound contains aluminum, the compound includes, for example, trimethoxyaluminate, triethoxyaluminate, tripropoxyaluminate, tetraethoxyaluminate.

When X is Ti, or that is when the compound contains titanium, it includes, for example, trimethoxytitanate, tetramethoxytitanate, triethoxytitanate, tetraethoxytitanate, tetrapropoxytitanate, chlorotrimethoxytitanate, chlorotriethoxytitanate, ethyltrimethoxytitanate, methyltriethoxytitanate, ethyltriethoxytitanate, diethyldiethoxytitanate, phenyltrimethoxytitanate, phenyltriethoxytitanate.

When X is Zr, or that is, when the compound contains zirconium, it includes, for example, zirconates that correspond to those exemplified hereinabove for the titanium-containing compound.

### [Preparation of Hydrophilic Coating Liquid]

In preparing the hydrophilic coating liquid composition, it may additionally contain any other hydrophilic polymer. The hydrophilic polymer may be obtained through polymerization of a hydrophilic monomer such as those mentioned in the above for forming the hydrophilic graft polymer chain. The content of the hydrophilic polymer is preferably from 10% by weight to less than 50% by weight in terms of the solid content thereof. When the content is 50% by weight or more, then the film strength may lower; and when it is less than 10% by weight, then the film properties may worsen and the possibility of film cracking may increase. Therefore, the content overstepping the above range is unfavorable.

In the preferred embodiment where a hydrolyzable compound is added to the hydrophilic coating liquid composition in preparing it, the amount of the hydrolyzable compound to be added is preferably such that the polymerizing group in the hydrolyzable compound may be 5 mol % or more relative to the specific element alkoxide group in the hydrophilic graft polymer, more preferably 10 mol % or more. The uppermost limit of the amount of the crosslinking agent to be added is not particularly limited, if the agent can well crosslink the hydrophilic polymer. However, if it is added too much, then it may cause a problem in that the crosslinking agent not participating in the crosslinking reaction may be sticky on the hydrophilic surface produced.

A liquid prepared by dissolving a hydrolyzable compound (crosslinking agent) and preferably a hydrophilic polymer further in a solvent is the hydrophilic coating liquid for use in the invention, and this is applied onto a hydrophilic graft polymer having an alkoxide group of an element selected from Si, Ti, Zr and Al such as a silane-coupling group, or an amido group introduced thereinto, and then heated and dried, whereby these components are hydrolyzed and polycondensed to give a surface hydrophilic layer (organic-inorganic hybrid) having high hydrophilicity and high film strength. In forming the organic-inorganic hybrid, it is desirable that an acidic catalyst or a basic catalyst is used for promoting the hydrolysis and polycondensation reaction. For obtaining a practically favorable reaction efficiency, the catalyst is indispensable.

For the catalyst, usable is an acid or a basic compound directly as it is, or it may be dissolved in a solvent such as water or alcohol and the resulting solution may be used (hereinafter these are respectively referred to as an acidic catalyst and a basic catalyst). The concentration of the compound to be dissolved in a solvent is not particularly limited, it may be suitably determined depending on the properties of the acid or the basic compound used and on the desired amount of the catalyst to be used herein. The catalyst having a higher concentration may promote more the hydrolysis and polycondensation. However, when a basic catalyst having a high concentration is used, then a precipitate may be formed in the sol. Therefore, when a basic catalyst is used, then its concentration is preferably at most 1 N in terms of the concentration in its aqueous solution.

The type of the acidic catalyst or the basic catalyst is not particularly limited. In case where a catalyst having a high concentration is necessarily used, then the catalyst is preferably composed of elements not almost remaining in the coating film after dried.

Specifically, the acidic catalyst includes hydrogen halide such as hydrochloric acid; nitric acid, sulfuric acid, sulfurous acid, hydrogen sulfide, perchloric acid, hydrogen peroxide, carbonic acid; carboxylic acid such as formic acid, acetic acid; substituted carboxylic acid having a structural formula of RCOOH where R is substituted with any other element or substituent; and sulfonic acid such as benzenesulfonic acid. The basic catalyst includes ammoniac base such as aqueous ammonia; and amine such as ethylamine, aniline.

The hydrophilic coating liquid may be prepared by dissolving a hydrolyzable compound and a hydrophilic polymer in a solvent such as ethanol, adding the above catalyst thereto, and stirring it. The reaction temperature may be from room temperature to 80° C., and the reaction time, or that is the time for which the system is kept stirred may be preferably from 1 to 72 hours. The stirring promotes the hydrolysis and polycondensation of both components to give an organic-inorganic hybrid sol.

The solvent to be used in preparing the hydrophilic coating liquid composition that contains a hydrolyzable compound and preferably a hydrophilic polymer is not particularly limited, if it may be capable of uniformly dissolving and dispersing the components. For example, the solvent is preferably an aqueous solvent such as methanol, ethanol, and water or the like.

As described hereinabove, the formation of the surface hydrophilic layer (organic-inorganic hybrid) in the invention relies on a sol-gel process. The sol-gel process is described in detail in publications such as Sumio Sakuhana, “Sol-gel-hou no kagaku” (“Science of Sol-Gel Process”), published by Agne-Shofu, 1988; Ken Hirashima, “Saishin sol-gel-hou niyoru kinouseihakumaku sakusei gijyuts” (“Functional Thin Film Formation Technology according to Newest Sol-Gel Process”), published by General Technology Center, 1992. The methods described in these may apply to the formation of the surface hydrophilic layer (organic-inorganic hybrid) in the invention.

Not detracting from the advantages of the invention, the hydrophilic coating liquid composition in the invention may contain various additives depending on its object. For example, surfactant or the like may be added in the hydrophilic coating liquid for improving the uniformity of the coating liquid.

The hydrophilic surface in the invention may be produced by applying the hydrophilic coating liquid composition onto a suitable substrate having a hydrophilic graft polymer, and heating and drying it to form a surface hydrophilic layer thereon. The heating temperature and the heating time for forming the hydrophilic layer is not particularly limited, if the solvent could be removed from the coating liquid to give a tough film on the substrate. From the viewpoint of the production efficiency, the heating temperature is preferably 200° C. or lower, and crosslinking time is preferably within 1 hour.

In the manner as above, a gas barrier layer having an organic-inorganic hybrid may be provided on the surface of the support or the surface layer provided on the support. The thickness of the gas barrier layer may be selected depending on the object thereof. In general, it is preferably from 0.1 μm to 10 μm, more preferably from 0.5 μm to 10 μm. Having a thickness falling within the range, the film may exhibit favorable gas barrier capability and durability, and, in addition, the thickness range is favorable since the film is hardly curled and its flexibility and folding resistance may lower little.

The substrate to constitute the support may be any one having mechanical strength and dimensional stability. In case where the gas barrier film is required to have visibility through it, then a transparent film is preferably used as the substrate.

Specifically, the film for the substrate includes polyester films such as polyethylene terephthalate films, polyethylene terephthalate-based copolyester films, polyethylene naphthalate films; polyamide films such as nylon 66 films, nylon 6 films, metaxylylenediamine copolyamide films; polyolefin films such as polypropylene films, polyethylene films, ethylene-propylene copolymer films; polyimide films; polyamidimide films; polyvinyl alcohol films; ethylene-vinyl alcohol copolymer films; polyphenylene films; polysulfone films; polyphenylene sulfide films. Among them, preferred are polyester films such as polyethylene terephthalate films, and polyolefin films such as polyethylene films and polypropylene films, in view of their cost performance, transparency, gas barrier capability. These films may be stretched or unstretched, and may be used singly or as laminates of films having different properties.

If it is not detracting from the advantages of the invention, the film used as the substrate in the invention may contain various additives and stabilizers added thereto, or may be coated with them. The additives include, for example, antioxidant, antistatic agent, UV inhibitor, plasticizer, lubricant, heat stabilizer. In addition, the film may be subjected to surface treatment of corona treatment, plasma treatment, glow discharge treatment, ion bombardment treatment, chemical treatment, solvent treatment, surface-roughening treatment.

The thickness of the substrate may be suitably determined in consideration of its aptitude for its use for wrapping materials, and is therefore not particularly limited. From the viewpoint of general practical use thereof, the substrate preferably has a thickness of from 3 μm to 1 mm; and from the viewpoint of the flexibility and the workability thereof to form inorganic thin films, the thickness of the substrate is more preferably from 10 to 300 μm.

The substrate may be directly used for a support as it is when it may generate an active site through energy impartation thereto, but for the purpose of more efficiently generating the initiation site for forming graft polymer chains, it is desirable that a polymerization initiator-containing surface layer (hereinafter this may be referred to as a specific polymerization initiating layer) may be provided on the surface of the substrate to be a support. In particular, from the viewpoint of the stability and the durability thereof, it is desirable that a polymerization initiating layer is provided on the surface of the substrate by fixing a polymerization initiator through crosslinking reaction thereon to be a support for use herein.

The specific polymerization initiating layer may be formed by fixing a polymer having a polymerization initiation capability-having functional group and a crosslinking group in the side chain thereof, through crosslinking reaction on a substrate.

The formation of the polymerization initiating layer is described in detail in the present applicant's prior JP-A No. 2005-284011, paragraphs [0009] to [0052], and the techniques are applicable to the invention.

The formation of the polymerization initiating layer are described below in detail.

A polymerization initiating group-having polymer (this may be hereinafter referred to as a specific polymerization initiating polymer) to be used in forming the polymerization initiating layer is described.

The specific polymerization initiating polymer indispensably has a polymerization initiating group in the structure of the polymer, and is preferably prepared through polymerization of a monomer having a polymerization initiating group.

### [Monomer Having Polymerization Initiating Group]

Preferably, the monomer having a polymerization initiating group to constitute the specific polymerization initiating polymer is a monomer having a radical, anionic or cationic polymerizable group that has a polymerization initiation capability-having structure pendent therewith. That is, the monomer has a structure having both a polymerizable group and a polymerization initiating group in the molecule.

The polymerization initiation capability-having structure includes (a) aromatic ketones, (b) onium salt compounds, (c) organic peroxides, (d) thio compounds (e) hexaarylbiimidazole compounds, (f) ketoxime ester compounds, (g) borate compounds, (h) azinium compounds, (i) active ester compounds, (j) carbon-halogen bond-having compounds, (k) pyridinium compounds. From the viewpoint of the polymerization initiation capability thereof, preferred are (a), (c), and (j). Any of the above compounds (a) to (k) are usable herein. Examples of the compounds (a), (c) and (j) especially preferred for use in the invention are described below, to which, however, the invention should not be limited.

The above-mentioned monomer may be polymerized to give the specific polymerization initiating polymer in the invention. It may be polymerized in any manner, for which preferred is radical polymerization as being simple. In this, the radical generator to cause the radical polymerization is preferably a compound capable of generating a radical under heat.

The weight-average molecular weight of the specific polymerization initiating polymer in the invention is preferably from 10,000 to 10,000,000, more preferably from 10,000 to 5,000,000, particularly preferably from 100,000 to 1,000,000. When the weight-average molecular weight of the specific polymerization initiating polymer in the invention is smaller than 10,000, then the polymerization initiating layer may apt to dissolve in the monomer solution.

The preferred range of the weight-average molecular weight as referred to herein may apply also to the specific polymerization initiating polymer copolymerized with a crosslinking group-having monomer and any other third comonomer that will be described hereinunder.

Preferably, the specific polymerization initiating polymer in the invention has a crosslinking group in addition to the above-mentioned polymerization initiating group. Having a crosslinking group, the specific polymerization initiating polymer may form a tougher specific polymerization initiating layer in which the polymerization initiating group bonds to the polymer chain and the polymer chain is fixed through crosslinking reaction and in which the initiator component is effectively prevented from being released out.

In the invention, a graft polymer is formed on the surface of the specific polymerization initiating layer, as described below. Since the specific polymerization initiating layer is provided as in the above, the solution that contains a polymerizing compound, which is a material to form the graft polymer, is prevented from penetrating into the polymerization initiating layer when it is contacted with it or is applied onto it. In forming the specific polymerization initiating layer, a specific polymerization initiating polymer having a crosslinking group is used, and accordingly, it may utilize not only an ordinary radical crosslinking reaction but also a condensation or addition reaction between the polar groups, and is therefore capable of forming a tougher crosslinked structure. As a result, it is possible to more effectively prevent the initiator component from being released out from the polymerization initiating layer and to prevent the polymerizing compound from penetrating into the specific polymerization initiating layer.

The specific polymerization initiating polymer having a crosslinking group may be prepared through copolymerization of the above-mentioned monomer having a polymerization initiating group and a monomer having a crosslinking group.

### [Crosslinking Group-Having Monomer]

Preferably, the crosslinking group-having monomer that constitutes the specific polymerization initiating polymer in the invention is a radical, anionic or cationic-polymerizable group-having monomer that has a conventional known crosslinking group (functional group having a structure usable in crosslinking reaction) pendent therewith, for example, as in Shinji Yamashita, “Kakyozai Handbook” (“Crosslinking Agent Handbook”). That is, the monomer has a structure having both a polymerizable group and a crosslinking group in the molecule.

Of the conventional known crosslinking group, any of a carboxylic acid group (—COOH), a hydroxyl group (—OH), an amino group (—NH₂) or an isocyanate group (—NCO) is preferably pendent with the polymerizing group.

One such crosslinking group may be pendent with the polymerizing group, or two or more such groups may be pendent therewith.

The polymerizing group having such a crosslinking group pendent therewith includes a radical, anionic or cationic-polymerizable group such as an acrylic group, a methacrylic group, an acrylamido group, a methacrylamido group, a vinyl group. Above all, especially preferred are an acrylic group and a methacrylic group as the compounds are easy to produce.

In the specific polymerization initiating polymer in the invention, the copolymerization molar ratio of the polymerization initiating group-having comonomer (A) to the crosslinking group-having comonomer (B) is preferably such that (A) is from 1 to 40 mol % and (B) is from 20 to 70 mol %. From the viewpoint of the filmy properties of the polymerization initiating layer after the graft polymerization reaction and the crosslinking reaction, (A) is more preferably from 5 to 30 mol %, and (B) from 30 to 60 mol %.

The specific polymerization initiating polymer in the invention may be further copolymerized with any other comonomer other than the above, for the purpose of controlling the film formability, the hydrophilicity/hydrophobicity, the solvent solubility and the polymerization initiation capability thereof.

[Polymerization Initiating Layer with Specific Polymerization Initiating Polymer Fixed Therein Through Crosslinking Reaction]

In a process of forming a polymerization initiating layer, a specific polymerization initiating polymer is fixed through crosslinking reaction, for which, for example, herein employable is a method of self-condensation of the specific polymerization initiating polymer, or a method of using a crosslinking agent. Preferred is the method of using a crosslinking agent. In the method of self-condensation of a specific polymerization initiating polymer, for example, when the crosslinking group is —NCO, the self-condensation of the polymer goes on under heat. With the self-condensation going on, a crosslinked structure may be formed.

### [Film Formation of Polymerization Initiating Layer]

In this process, the above-mentioned, specific polymerization initiating polymer is dissolved in a suitable solvent to prepare a coating liquid, then the coating liquid is disposed on a suitable substrate by applying it thereonto, and thereafter the solvent is removed and the crosslinking reaction goes on to form a film.

In forming the film of the polymerization initiating layer, when a specific polymerization initiating polymer produced from a monomer having a polymerization initiating group is used alone, then the crosslinking reaction is unnecessary. In this case, a coating liquid may be prepared, then the coating liquid may be disposed on a substrate by applying it thereonto, and the solvent may be removed (by drying), like in the above.

### (Solvent)

Not particularly limited, the solvent to be used in forming the polymerization initiating layer by coating may be any one capable of dissolving the above-mentioned, specific polymerization initiating polymer. From the viewpoint of the easiness in drying and the operability, preferred is a solvent of which the boiling point is not too high. Specifically, a solvent having a boiling point of from 40° C. to 150° C. may be selected.

One or more different types of such solvents may be used either singly or as combined. The solid matter content of the coating solution may be suitably from 2 to 50% by mass.

The coating amount of the polymerization initiating layer is preferably from 0.1 to 20 g/m², more preferably from 0.1 to 15 g/m², in terms of the dry weight thereof from the viewpoint of satisfying both sufficient polymerization initiation capability expression and excellent filmy properties.

The gas barrier film of the invention has good adhesiveness to the support surface owing to the hydrophilic graft polymer chains introduced into the support surface and to the high-density crosslinked structure formed between the graft polymer chains, therefore having the advantages of gas barrier capability and durability thereof.

The gas barrier film of the invention can be produced in a relatively simple process, and the organic-inorganic hybrid having excellent gas barrier capability therein has good durability, and therefore the film has another advantage in that it is favorably used for wrapping materials of many applications.

### EXAMPLES

The invention is further described with reference to the following Examples, to which, however, the invention should not be limited.

### Example 1

### Formation of Support

A biaxially-stretched polyethylene terephthalate film (A4100, by TOYOBO CO., LTD.) having a thickness of 188 μm was used as a substrate. This was subjected to oxygen glow treatment under the condition mentioned below, using a lithographic magnetron sputter for glow treatment (CFS-10-EP70 manufactured by SHIBAURA ELETEC CORPORATION), to prepare a substrate A.

(Oxygen glow treatment condition)

| | |
|---|---|
| Initial vacuum: | 1.2 × 10⁻³ Pa |
| Oxygen pressure: | 0.9 Pa |
| RF glow: | 1.5 kW |
| Treatment time; | 60 sec |

### (Introduction of Graft Polymer—1)

Next, a mixture solution of N,N-dimethylacrylamide, methacryloxypropyltriethoxysilane and ethanol (concentration: 50 wt. %) was bubbled with nitrogen. The above substrate A was dipped in the mixture solution at 70° C. for 7 hours. The dipped film was well washed with ethanol to give a support B, which has hydrophilic graft polymer chains and has a specific element alkoxide group of a silane-coupling group, and an amido group in the graft chain structure thereof. The contact angle of water to the support B having a graft polymer layer was 52°.

### [Formation of Organic-Inorganic Hybrid (Gas Barrier Layer)]

The obtained support B was coated with a coating liquid composition 1 that had been prepared by stirring ethanol, water, tetraethoxysilane and phosphoric acid in the amount mentioned below, at room temperature for 24 hours, and then dried by heating at 100° C. for 10 minutes to form a gas barrier layer of an organic-inorganic hybrid, therefore obtaining a gas barrier film 1.

(Coating liquid composition 1)

| | |
|---|---|
| Tetraethoxysilane (crosslinking component) | 0.9 g |
| Ethanol | 3.7 g |
| Water | 8.7 g |
| Aqueous phosphoric acid solution (aqueous 0.85% solution) | 1.3 g |

### Example 2

A gas barrier film 2 was obtained in the same manner as in Example 1, except that the 0.9 g of tetraethoxysilane contained in the coating liquid composition 1 used for forming the organic-inorganic hybrid material in Example 1 was changed to 1.0 g of tetramethoxytitanate.

### Example 3

A gas barrier film 3 was obtained in the same manner as in Example 1, except that the 0.9 g of tetraethoxysilane contained in the coating liquid composition 1 used for forming the organic-inorganic hybrid material in Example 1 was changed to 1.6 g of tetramethoxyzirconate.

### Example 4

A gas barrier film 4 was obtained in the same manner as in Example 1, except that the 0.9 g of tetraethoxysilane contained in the coating liquid composition 1 used for forming the organic-inorganic hybrid material in Example 1 was changed to 0.7 g of trimethoxyaluminate.

### Example 5

### Introduction of Graft Polymer—2

An aqueous acrylamide solution (concentration: 50 wt. %) was bubbled with nitrogen. The substrate A used in Example 1 was dipped in the solution at 70° C. for 7 hours. The dipped film was well washed with distilled water to give a support C, which has hydrophilic graft polymer chains and has an amido group in the structure thereof. The contact angle of water to the support C having a graft polymer layer was 25.5°.

### [Formation of Organic-Inorganic Hybrid (Gas Barrier Layer)—2]

The obtained support C was coated with a coating liquid composition 2 that had been prepared by stirring methanol, water, tetraethoxysilane and phosphoric acid in the amount mentioned below, at room temperature for 5 hours, and then dried by heating at 100° C. for 10 minutes to form a gas barrier layer of an organic-inorganic hybrid, therefore obtaining a gas barrier film 5.

(Coating composition 2)

| | |
|---|---|
| Methanol | 3.7 g |
| Tetraethoxysilane (crosslinking component) | 0.9 g |
| Water | 11.7 g |
| Aqueous phosphoric acid solution (aqueous 0.85% solution) | 1.0 g |

### Example 6

### Introduction of Graft Polymer—3

A methacryloxypropyltriethoxysilane/ethanol solution (concentration: 50 wt. %) was bubbled with nitrogen. The substrate A was dipped in the solution at 70° C. for 7 hours. The dipped film was well washed with distilled water to give a support D, which has hydrophilic graft polymer chains and has a specific element alkoxide group of a silane-coupling group in the structure thereof. The contact angle of water to the support D having a graft polymer layer was 78.5°.

### [Formation of Organic-Inorganic Hybrid (Gas Barrier Layer)]

The obtained support D was coated with a coating liquid composition 3 that had been prepared by stirring 2-propanol, water, tetraethoxysilane and phosphoric acid in the amount mentioned below, at room temperature for 5 hours, and then dried by heating at 100° C. for 10 minutes to form a gas barrier layer of an organic-inorganic hybrid, therefore obtaining a gas barrier film 6.

(Coating composition 3)

| | | |
|---|---|---|
| 2-Propanol | 8 | g |
| Tetraethoxysilane (crosslinking component) | 1.0 | g |
| Water | 1.0 | g |
| Aqueous phosphoric acid solution (aqueous 0.85% solution) | 1.0 | g |

### Comparative Example 1

### Introduction of Graft Polymer—4

Aqueous sodium styrenesulfonate solution (concentration: 10 wt. %) was bubbled with nitrogen. The substrate A described in Example 1 was dipped in the solution at 70° C. for 7 hours. The dipped film was well washed with water to give a support E of a surface graft film in which sodium styrenesulfonate was grafted in the surface thereof. The contact angle of water to the support E having a graft polymer layer was 65°.

### (Formation of Inorganic Thin Film by Vapor Phase Method)

On the obtained support E, formed was a film of aluminum oxide by sputtering to give a gas barrier film 7 of Comparative Example 1.

Briefly, the support E was set in a sputtering device, which was degassed to 1.3 mPa, and a mixed gas of argon/oxygen in a ratio by volume of 98.5/1.5 was introduced thereinto. The atmospheric pressure in this was set at 0.27 PA, the temperature of the support D was set at 50° C. Under the condition the support D was DC sputtered at a power of 1 W/cm². The thickness of the thus formed inorganic thin film was 50 nm.

### Comparative Example 2

A styrene/methyl ethyl ketone solution (concentration: 50 wt. %) was bubbled with nitrogen. The substrate A described in Example 1 was dipped in the solution at 70° C. for 7 hours. The dipped film was well washed with methyl ethyl ketone to give a support F of a surface graft film in which styrene was grafted in the surface thereof. The contact angle of water to the support F having graft polymer layer was 98°.

In place of the support B used in Example 1, the support F was processed in the same manner as in Example 1 to give an organic-inorganic hybrid film 8.

### Comparative Example 3

A gas barrier film 9 was obtained in the same manner as in Example 1, except that the support B used in Example 1 was changed to polyethylene terephthalate.

### Evaluation

### 1. Evaluation of Performance of Gas Barrier Film

The gas barrier films 1 to 9 obtained in Examples 1 to 6 and Comparative Examples 1 to 3 were tested for their performance, according to the methods mentioned below. The results are given in Table 1 below.

### 1-1. Oxygen Transmittance

Using oxygen transmittance gauge (OX-TRAN 100 TWIN Model) manufactured by MOCON, Inc., the sample was analyzed at 25° C. and a relative humidity of 90% for its oxygen transmittance. The samples having an oxygen transmittance of 1.0 ml/m²·24 hrs or less are good for practical use in point of their oxygen-barrier capability.

### 1-2. Water Vapor Transmittance

According to a moisture permeability test method (cup method) of JIS Z 0208 for moisture-proof wrapping material, the sample was analyzed at 40° C. and a relative humidity of 90% for its water vapor transmittance. The samples having a water vapor transmittance of at most 1.0 g/m²·24 hrs are good for practical use in point of their water vapor-barrier capability.

### 2. Evaluation of Film Adhesiveness

The obtained gas barrier films 1 to 9 were tested for their film adhesiveness, according to a cross-cut tape-peeling method of Japan Industrial Standard (JIS) 5400. Briefly, the film surface was cut into 1 cm² divisions spaced from each other with an interval of 1 mm (100 divisions), and the surface was tested three times for a peeling test with an adhesive tape. After the test, the number of the remaining divisions was counted.

### 3. Evaluation of Transparency

With air as a reference, the light transmittance of the sample at a wavelength of 550 nm was determined, using a UV to visible spectrophotometer UV2400-PC (by Shimadzu). This indicates the transparency of the sample. The samples having a light transmittance of at least 90% are good.

TABLE 1

| | | Oxygen | Water Vapor | | |
|---|---|---|---|---|---|
| | | Transmittance | Transmittance | Film | |
| | | (ml/m² · 24 hrs) | (g/m² · 24 hrs) | Adhesiveness | Transparency |
| Example 1 | Gas barrier film 1 | 0.2 | 0.3 | 100/100 | good |
| Example 2 | Gas barrier film 2 | 0.3 | 0.7 | 100/100 | good |
| Example 3 | Gas barrier film 3 | 0.3 | 0.5 | 100/100 | good |
| Example 4 | Gas barrier film 4 | 0.2 | 0.6 | 100/100 | good |
| Example 5 | Gas barrier film 5 | 0.3 | 0.6 | 98/100 | good |
| Example 6 | Gas barrier film 6 | 0.3 | 0.4 | 100/100 | good |
| Comparative | Gas barrier film 7 | 0.3 | 0.4 | 40/100 | good |
| Example 1 | | | | | |
| Comparative | Gas barrier film 8 | 0.4 | 0.5 | 6/100 | good |
| Example 2 | | | | | |
| Comparative | Gas barrier film 9 | 0.4 | 0.6 | 5/100 | good |
| Example 3 | | | | | |

The results in Table 1 confirm that the gas barrier films 1 to 6 of the invention are excellent in the oxygen-barrier capability and the water vapor-barrier capability, and that the adhesiveness of the gas barrier layer of the organic-inorganic hybrid formed on their surface is good. Further, it has been seen that the gas barrier films of Examples 1 to 6 have high transparency and are useful as being suitable to practical use. In addition, it has also been seen that, as compared with the layer not containing a silane-coupling layer but containing an amido group alone, the layer that contains a silane-coupling layer is excellent in the adhesiveness to a certain degree. Even the gas barrier film 7 of Comparative Example 1 in which the inorganic thin film was formed according to a vapor-phase method after the formation of the graft polymer layer, and the gas barrier films 8 and 9 of Comparative Examples 2 and 3 in which the support having a styrene graft polymer layer or the polyethylene terephthalate film support was used could exhibit excellent gas barrier capability in their initial stage, but their adhesiveness to the substrate is insufficient. From this, it is understood that, only when the organic-inorganic composite of the invention is applied, the film adhesiveness to the substrate is more improved.

As described in the above, the invention provides an organic-inorganic hybrid material having a high-density crosslinked structure and applicable to various fields, a gas barrier film excellent in the adhesiveness between the base film and the gas barrier layer thereon and in its durability, and excellent in visibility therethrough and in its gas barrier capability, and a method for producing it.

The disclosure in Japanese Patent Application No. 2005-358182 and No. 2006-95443 are incorporated herein by reference in its entirely.

All the literature, the patent applications and the technical standards referred to in this description are hereby incorporated in this description to the same degree as that of a case where the fact that the individual literature, patent application and technical standard are incorporated therein by reference is concretely and individually described.

### INDUSTRIAL APPLICABILITY

The organic-inorganic hybrid material of the invention is useful as a gas-barrier layer in gas-barrier films as so mentioned above; and apart from gas-barrier films, it is also favorably used for high-functional materials such as contact lenses, non-linear optical materials, photochromic materials, electroconductive materials, etc.

1. An organic-inorganic hybrid material comprising:
a support, and
a graft polymer layer containing a graft polymer chain directly bonding to a surface of the support or a surface layer provided on the support, the graft polymer layer containing an inorganic component comprising a crosslinked structure formed through hydrolysis and polycondensation of an alkoxide of an element selected from Si, Ti, Zr and Al.

2. The organic-inorganic hybrid material of claim 1, wherein the alkoxide is an alkoxide of Si.

3. The organic-inorganic hybrid material of claim 1, wherein a contact angle of water to a surface of the graft polymer layer is 90° or less, and the graft polymer layer contains the inorganic component comprising a crosslinked structure formed through hydrolysis and polycondensation of an alkoxide of an element selected from Si, Ti, Zr and Al.

4. The organic-inorganic hybrid material of claim 1, wherein the graft polymer chain comprises an alkoxide group of an element selected from Si, Ti, Zr and Al.

5. The organic-inorganic hybrid material of claim 1, wherein the graft polymer chain comprises an amido group.

6. A gas barrier film comprising:
a support, and
a gas barrier layer comprising a graft polymer layer containing a graft polymer chain directly bonding to a surface of the support or a surface layer provided on the support, the graft polymer layer containing an inorganic component comprising a crosslinked structure formed through hydrolysis and polycondensation of an alkoxide of an element selected from Si, Ti, Zr and Al.

7. The gas barrier film of claim 6, wherein the alkoxide is an alkoxide of Si.

8. The gas barrier film of claim 6, wherein a contact angle of water to a surface of the gas barrier layer is 90° or less, and the gas barrier layer contains the inorganic component comprising a crosslinked structure formed through hydrolysis and polycondensation of an alkoxide of an element selected from Si, Ti, Zr and Al.

9. The gas barrier film of claim 6, wherein the graft polymer chain comprises an alkoxide group of an element selected from Si, Ti, Zr and Al.

10. The gas barrier film of claim 6, wherein the graft polymer chain comprises an amido group.

11. A method for producing a gas-carrier film comprising:
generating a graft polymer chain directly bonding to a surface of a support or a surface layer provided on the support, thereby forming a graft polymer layer containing a graft polymer chain; and
forming a crosslinked structure in the graft polymer layer through hydrolysis and polycondensation of an alkoxide of an element selected from Si, Ti, Zr and Al.

12. The method for producing a gas barrier film of claim 11, wherein the support surface layer is formed by providing a polymerization initiating layer which is formed by fixing a polymerization initiator on the surface of the support through a crosslinking reaction.
